(19) United States
(12) Patent Application Publication
(10) Pub. No.: US 2023/0059444 A1
(43) Pub. Date: Feb. 23, 2023

(54) ENVIRONMENT DETECTION SYSTEM

(71) Applicant: DAIKIN INDUSTRIES, LTD., Osaka (JP)

(72) Inventors: Takehiko HIEI, Osaka (JP); Mamoru OKUMOTO, Osaka (JP); Kiyoshi KUROI, Osaka (JP)

(21) Appl. No.: 17/975,294

(22) Filed: Oct. 27, 2022

Related U.S. Application Data
(63) Continuation of application No. PCT/JP2021/017020, filed on Apr. 28, 2021.

(30) Foreign Application Priority Data
Apr. 30, 2020 (JP) 2020-080079

(51) Int. Cl. G01N 29/024; G01N 29/22; G01N 29/14; F24F 11/79

(52) U.S. Cl. CPC G01N 29/024; F24F 11/79; G01N 29/14; G01N 29/222; F24F 2110/10; G01N 2291/0215; G01N 2291/02881

(57) ABSTRACT

An environment detection system includes a sound wave transmitter, a sound wave receiver, and a determination unit. The sound wave transmitter transmits a detection sound wave to a target space where an environment control device that conditions air in a space is installed. The sound wave receiver receives the detection sound wave transmitted by the sound wave transmitter. The determination unit determines a temperature or an air velocity in a first region near the environment control device, based on predetermined acquired information acquired from the environment control device. The environment detection system obtains a temperature or air velocity distribution in the target space, based on measured sound wave data. A temperature or air velocity distribution in a second region is obtained based on at least either the temperature or the air velocity in the first region determined by the determination unit and the measured sound wave data.

### CROSS-REFERENCE TO RELATED APPLICATIONS

This is a continuation of International Application No. PCT/JP2021/017020 filed on Apr. 28, 2021, which claims priority to Japanese Patent Application No. 2020-080079, filed on Apr. 30, 2020. The entire disclosures of these applications are incorporated by reference herein.

### BACKGROUND

### Technical Field

The present disclosure relates to an environment detection system.

### Background Art

A method in which the temperature distribution in a space is measured by sound waves has been known in the art. Japanese Unexamined Patent Publication No. H11-173925 discloses an environment-state measuring apparatus including a speaker that transmits sound waves into a space and a microphone that receives the sound waves transmitted by the speaker. This measuring apparatus measures the temperature distribution in a room based on the sound wave propagation time and the sound wave propagation distance from when the speaker transmits the sound wave to when the microphone receives the sound wave.

### SUMMARY

A first aspect of the present disclosure is directed to an environment detection system including a sound wave transmitter, a sound wave receiver, and a determination unit. The sound wave transmitter is configured to transmit a detection sound wave to a target space where an environment control device configured to condition air in a space is installed. The sound wave receiver is configured to receive the detection sound wave transmitted by the sound wave transmitter. The determination unit is configured to determine at least either a temperature or an air velocity in a first region near the environment control device, based on predetermined acquired information acquired from the environment control device. The environment detection system is configured to obtain at least either a temperature distribution or an air velocity distribution in the target space, based on measured sound wave data including a length of a sound wave propagation path and a sound wave propagation time, from when the sound wave transmitter transmits the detection sound wave to when the sound wave receiver receives the detection sound wave. At least either a temperature distribution or an air velocity distribution in a second region of the target space different from the first region is obtained based on at least either the temperature or the air velocity in the first region determined by the determination unit and the measured sound wave data.

### BRIEF DESCRIPTION OF THE DRAWINGS

FIG. 1 is a perspective view of a target space including an environment detection system according to an embodiment.

FIG. 2 is a piping system diagram illustrating a refrigerant circuit of an air conditioner according to the embodiment.

FIG. 3 is a vertical sectional view of an internal structure of an indoor unit according to the embodiment.

FIG. 4 is an enlarged view of the vicinity of an outlet of the indoor unit according to the embodiment, and illustrates a state where a flap is in the closed position.

FIG. 5 is an enlarged view of the vicinity of the outlet of the indoor unit according to the embodiment, and illustrates a state where the flap is in the open position.

FIG. 6 is a block diagram illustrating a control device and devices connected to the control device via communication lines.

FIG. 7 is a block diagram illustrating a configuration of the environment detection system according to this embodiment.

FIG. 8 is a schematic diagram showing the temperature distribution in a target space and propagation paths of sound waves.

FIG. 9 illustrates a method for measuring the temperature distribution and air velocity distribution in the target space.

FIG. 10 is a flowchart showing processes of measuring the temperature distribution and air velocity distribution in the target space, performed by the environment detection system.

FIG. 11 is a flowchart showing processes of measuring the temperatures and air velocities in a second region.

FIG. 12 is a vertical sectional view of an internal structure of an indoor unit according to a variation.

FIG. 13 corresponds to FIG. 11 and illustrates an environment detection system according to the variation.

FIG. 14 corresponds to FIG. 7 and illustrates an environment detection system according to a second embodiment.

FIG. 15 is a schematic view of an example of the air velocity distribution in an indoor space.

FIG. 16 is a schematic view of an example of the air age distribution in the indoor space.

### DETAILED DESCRIPTION OF EMBODIMENT(S

Embodiments will be described below with reference to the drawings. The following embodiments are merely exemplary ones in nature, and are not intended to limit the scope, application, or uses of the invention.

Note that the terms in the following description which indicate directions, such as “upper,” “top,” “lower,” “bottom,” “right,” and “left” refer to the directions shown in the drawings unless otherwise specified.

### FIRST EMBODIMENT

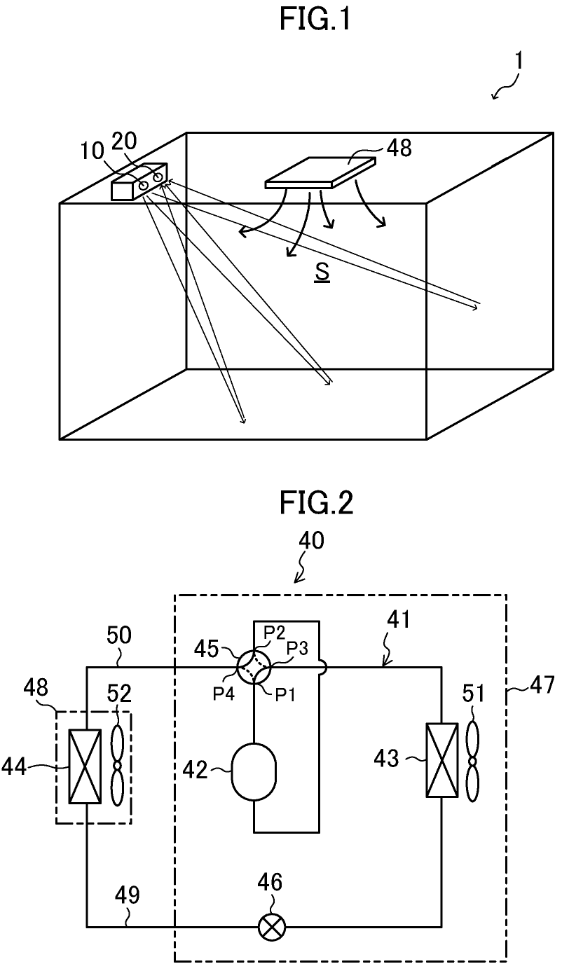

As illustrated in FIG. 1, an environment detection system (1) of this embodiment is a system that measures, by using sound waves, the temperature distribution and air velocity distribution in an indoor space (S) where an air conditioner (40) is installed. The indoor space (S) corresponds to a target space (S) of the present disclosure. The indoor space (S) is formed by the ceiling surface, the wall surfaces, and the floor surface. A speaker (10) and a microphone (20) are arranged at the same location near the ceiling of the indoor space (S). The speaker (10) is configured to transmit detection sound waves to the indoor space (S). The microphone (20) is configured to receive the detection sound waves.

### Air Conditioner

The air conditioner (40) is an environment control device (40) of the present disclosure. As illustrated in FIG. 2, the air conditioner (40) includes an indoor unit (48) and an outdoor unit (47). The indoor unit (48) of the air conditioner (40) is installed near the center of the ceiling of the indoor space (S). The indoor unit (48) sucks air into the indoor space (S), and blows conditioned air into the indoor space (S) (see the thick arrows in FIG. 1).

The air conditioner (40) performs a cooling operation and a heating operation. The air conditioner (40) includes a refrigerant circuit (41). The refrigerant circuit (41) is formed by connecting the outdoor unit (47) and the indoor unit (48) together through a liquid communication pipe (49) and a gas communication pipe (50). The refrigerant circuit (41) includes a compressor (42), an outdoor heat exchanger (43), an expansion valve (46), an indoor heat exchanger (44), and a four-way switching valve (45). The air conditioner (40) performs a refrigeration cycle operation in which a refrigerant circulates to cool and heat air in the indoor space (S).

### Outdoor Unit

The outdoor unit (47) is installed outdoors. As illustrated in FIG. 2, the outdoor unit (47) includes the compressor (42), the outdoor heat exchanger (43), the expansion valve (46), the four-way switching valve (45), and an outdoor fan (51).

The compressor (42) sucks and compresses a low-pressure gas refrigerant. The compressor (42) discharges the compressed refrigerant.

The outdoor heat exchanger (43) exchanges heat between outdoor air transported by the outdoor fan (51) and the refrigerant.

The outdoor fan (51) transports outdoor air passing through the outdoor heat exchanger (43).

The expansion valve (46) decompresses the refrigerant. The expansion valve (46) is an electric expansion valve having a variable opening degree. The expansion valve (46) merely needs to be connected to the liquid communication pipe (49) of the refrigerant circuit (41), and may be provided in the indoor unit (48).

The four-way switching valve (45) has a first port (P1), a second port (P2), a third port (P3), and a fourth port (P4). The first port (P1) communicates with the discharge side of the compressor (42). The second port (P2) communicates with the suction side of the compressor (42). The third port (P3) is connected to the gas end of the outdoor heat exchanger (43). The fourth port (P4) is connected to the gas communication pipe (50).

The four-way switching valve (45) switches between a first state (the state indicated by the solid curves in FIG. 2) and a second state (the state indicated by the broken curves in FIG. 2). In the first state, the first port (P1) and the third port (P3) communicate with each other, and the second port (P2) and the fourth port (P4) communicate with each other. In the second state, the first port (P1) and the fourth port (P4) communicate with each other, and the second port (P2) and the third port (P3) communicate with each other.

While the four-way switching valve (45) is in the first state, the refrigerant circuit (41) performs a first refrigeration cycle. In the first refrigeration cycle, the indoor heat exchanger (44) serves as an evaporator. In the first refrigeration cycle, the air conditioner (40) performs the cooling operation.

While the four-way switching valve (45) is in the second state, the refrigerant circuit (41) performs a second refrigeration cycle. In the second refrigeration cycle, the indoor heat exchanger (44) serves as a radiator. In the second refrigeration cycle, the air conditioner (40) performs the heating operation.

### Indoor Unit

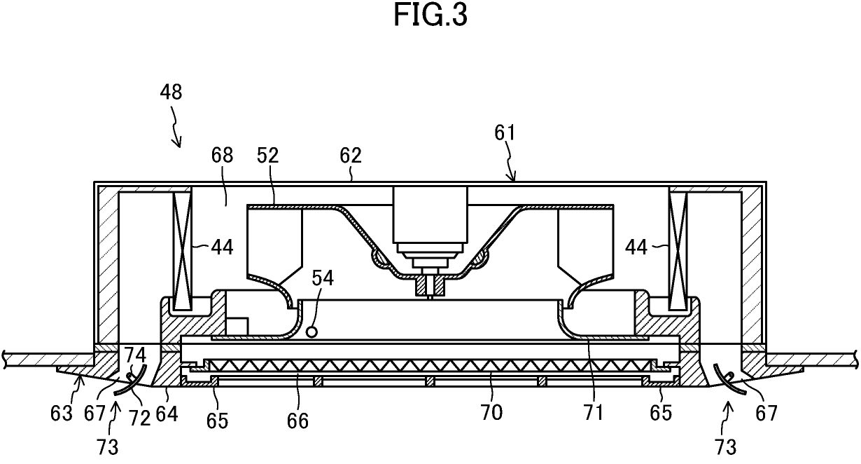

As illustrated in FIG. 3, the indoor unit (48) is a ceiling embedded indoor unit. The indoor unit (48) includes a casing (61), a filter (70), a bell mouth (71), an indoor fan (52), the indoor heat exchanger (44), and airflow direction regulators (73).

The casing (61) includes a casing body (62) and a panel (63). The casing body (62) is formed in the shape of a rectangular box with an open lower surface. The panel (63) is removably provided on the open surface of the casing body (62). The panel (63) includes a panel body (64) in the shape of a rectangular frame in plan view, and a suction grille (65) provided at the center of the panel body (64).

A single inlet (66) is formed in the center of the panel body (64). The inlet (66) is an opening through which air is to be sucked from the indoor space (S) so as to be introduced into the casing (61). The suction grille (65) is attached to the inlet (66).

Four side edge portions of the panel body (64) each have an outlet (67). The outlets (67) extend along the respective four side edges. The casing (61) includes therein an air passage (68) from the inlet (66) to the outlets (67). The outlets (67) are openings through each of which air that has passed through the indoor heat exchanger (44) is to be blown into the indoor space (S). Four corner portions of the panel (63) each have an auxiliary outlet continuous with associated one of the outlets (67).

The filter (70) is disposed above the suction grille (65). The filter (70) is disposed upstream of the indoor heat exchanger (44) in the air passage (68). The filter (70) catches dust in intake air that is sucked through the inlet (66).

The bell mouth (71) is disposed above the filter (70). The bell mouth (71) straightens the intake air.

The indoor fan (52) is a fan of the present disclosure. The indoor fan (52) is disposed upstream of the indoor heat exchanger (44) in the air passage (68). The indoor fan (52) is a centrifugal fan. The indoor fan (52) sends air from the inlet (66) to the outlets (67). The indoor fan (52) transports air sucked from near the bell mouth (71) to the indoor heat exchanger (44). The indoor fan (52) is configured to switch the volume of air therefrom among a plurality of levels.

The indoor heat exchanger (44) is the heat exchanger (44) of the present disclosure. The indoor heat exchanger (44) is disposed in the air passage (68). The indoor heat exchanger (44) is bent along the four side surfaces of the casing body (62). The indoor heat exchanger (44) regulates the temperature of the air sucked through the inlet (66). Specifically, the indoor heat exchanger (44) exchanges heat between the air transported by the indoor fan (52) and the refrigerant.

Each airflow direction regulator (73) regulates the direction of the air blown out of the associated outlet (67). The airflow direction regulator (73) includes a motor, a shaft (74) coupled to the motor, and a flap (72) rotating with the rotation of the shaft (74). The flap (72) is formed in the shape of a long plate extending along the side edge of the panel body (64) or along the longitudinal direction of the outlet (67). The vertical cross section of the flap (72) is substantially arc-shaped.

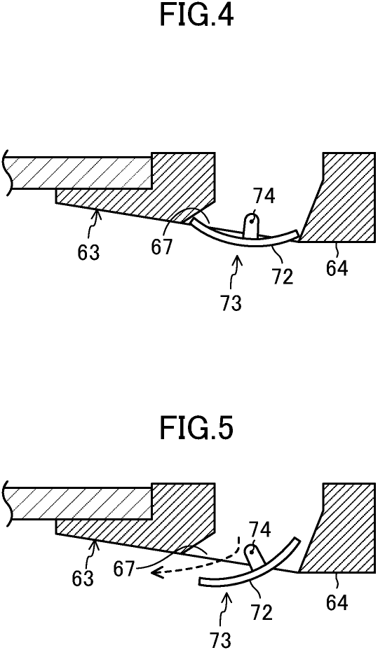

The positions to which the flap (72) of this example is shiftable include six positions. These six positions include the closed position illustrated in FIG. 4 and five open positions. The airflow direction of the air blown out of the outlet (67) can be set in five levels by the five open positions.

### Sensor

As illustrated in FIGS. 2 and 3, the indoor unit (48) includes a first temperature sensor (54). The first temperature sensor (54) is installed near the inlet (66). The first temperature sensor (54) detects the intake temperature that is the temperature of air sucked through the inlet (66) of the indoor unit (48).

### Control Device

A control device (100) controls the refrigerant circuit (41). The control device (100) controls the indoor unit (48) and the outdoor unit (47).

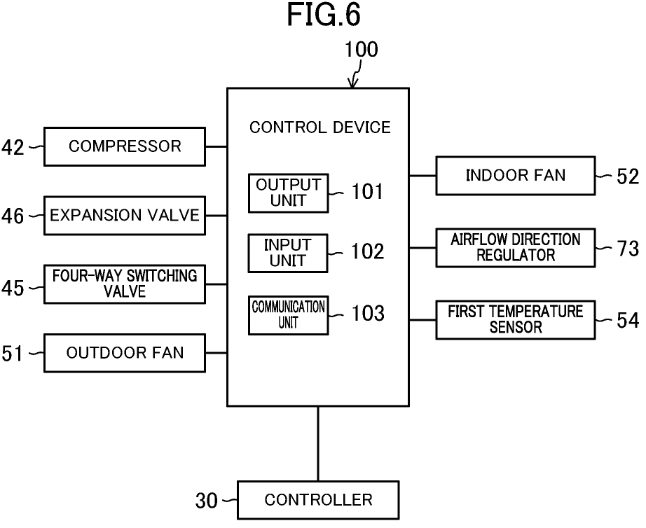

As shown in FIG. 6, the control device (100) is connected to the compressor (42), the expansion valve (46), the four-way switching valve (45), the outdoor fan (51), the indoor fan (52), the airflow direction regulators (73), and the first temperature sensor (54) in a wired or wireless manner. The control device (100) is connected to a controller (30) of an environment detection system to be described later in a wired or wireless manner.

The control device (100) includes an output unit (101), an input unit (102), and a communication unit (103). The output unit (101) outputs a control signal to at least each of the compressor (42), the expansion valve (46), the four-way switching valve (45), the outdoor fan (51), the indoor fan (52), and the flaps (72). The input unit (102) receives values respectively detected by the first temperature sensor (54). The communication unit (103) transmits acquired information to the controller (30) of the environment detection system (1) to be described later. The acquired information includes the value detected by the first temperature sensor (54), the rotational speed of the indoor fan (52), and the opening area of the inlet (66).

### Environment Detection System

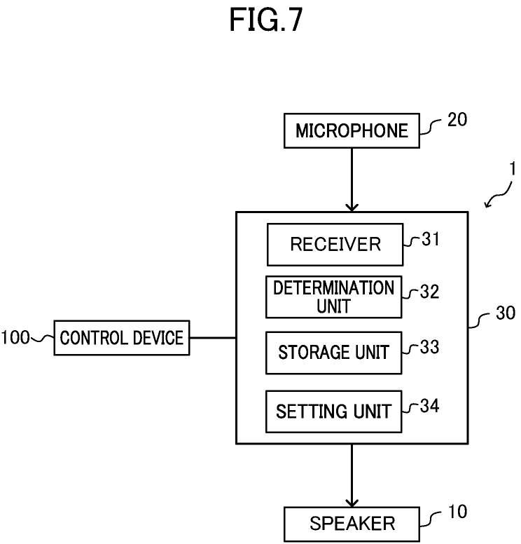

As shown in FIG. 7, the environment detection system (1) includes the speaker (10), the microphone (20), and the controller (30). The environment detection system (1) measures the temperature distribution and air velocity distribution in the indoor space (S), based on the time during which and the distance over which a detection sound wave propagates from when the speaker (10) transmits the detection sound wave to when the microphone (20) receives the detection sound wave.

The speaker (10) is a sound wave transmitter. The speaker (10) transmits detection sound waves. The speaker (10) transmits the detection sound waves in various directions in the indoor space (S). The plurality of detection sound waves transmitted from the speaker (10) propagates through the indoor space (S). Some of the detection sound waves are reflected off the floor surface, the wall surfaces, and other surfaces.

The microphone (20) is a sound wave receiver. The microphone (20) receives the detection sound waves transmitted by the speaker (10), and generates and outputs electric signals corresponding to the received detection sound waves. The microphone (20) directly receives the detection sound waves from the speaker (10), and receives the detection sound waves reflected off the floor surface and the wall surfaces. FIG. 1 shows that the microphone (20) has received the detection sound waves transmitted from the speaker (10) and reflected off the floor surface and the wall surfaces.

As illustrated in FIG. 7, the controller (30) includes a microcomputer mounted on a control board and a memory device (specifically, a semiconductor memory) that stores software for operating the microcomputer.

The controller (30) controls the speaker (10) based on an input signal input by an operator and a detection signal from the microphone (20). The controller (30) is connected to the speaker (10), the microphone (20), and the control device (100) of the air conditioner (40) via communication lines.

The controller (30) includes a setting unit (34), a storage unit (33), a receiver (31), and a determination unit (32).

The setting unit (34) divides the indoor space (S) into a plurality of regions Aₙ (n = 1, 2, ... n). The setting unit (34) groups the resultant regions Aₙ into a first region Ap and a second region Aq. As will be described in detail later, the first region Ap is a region near the air conditioner (40). The second region Aq corresponds to the regions Aₙ of the indoor space (S) except the first region Ap.

The storage unit (33) records path information. The path information includes the lengths of sound wave propagation paths from when the speaker (10) transmits detection sound waves to when the microphone (20) receives the detection sound waves. The path information is recorded in the storage unit (33) in advance. The lengths of the sound wave propagation paths refer to the lengths of the paths through which the detection sound waves transmitted at different angles from the speaker (10) propagate. As will be described in detail later, the detection sound waves pass through the respective regions Aₙ. Distance information indicates the distances over which the detection sound waves propagate through the respective regions An.

The receiver (31) receives the acquired information. The acquired information is sent from the communication unit (103) of the control device (100) included in the air conditioner (40).

The determination unit (32) determines that the intake temperature that is included in the acquired information and that is the value detected by the first temperature sensor (54) is the temperature of the first region Ap. The determination unit (32) calculates the intake air velocity that is the velocity of air sucked into the inlet (66), based on the rotational speed of the indoor fan (52) and the opening area of the inlet (66) that are included in the acquired information. The determination unit (32) determines that the calculated intake air velocity is the velocity of air through the first region Ap.

### Measurement of Temperature Distribution and Air Velocity Distribution

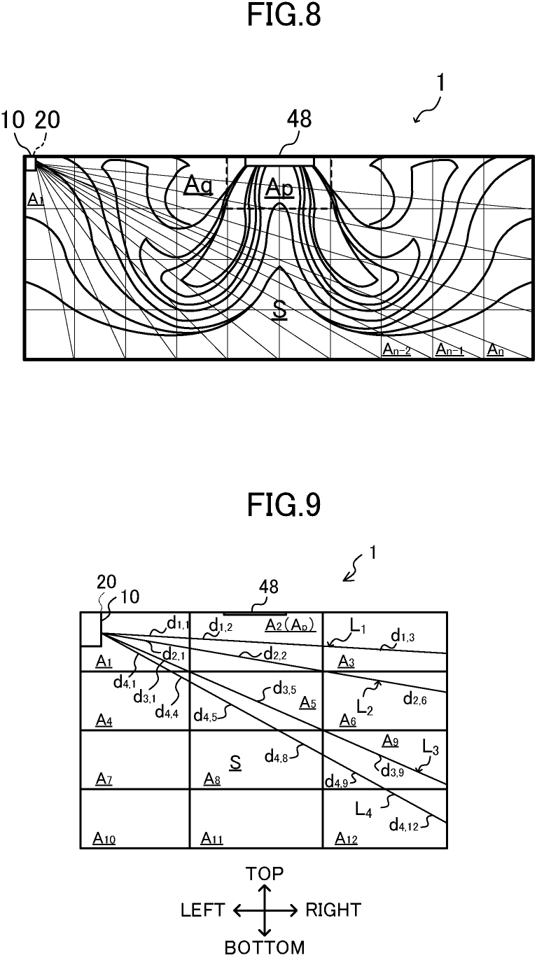

While air in the indoor space (S) is conditioned by the air conditioner (40), the temperature and air velocity in the indoor space (S) are not uniform. FIG. 8 shows the temperature distribution in the indoor space (S) while the air conditioner (40) is performing the heating operation. The temperature of the air blown out of the outlet (67) of the air conditioner (40) is highest, and the temperature decreases gradually with increasing distance from the air conditioner (40).

One or more detection sound waves transmitted from the speaker (10) pass through the respective regions Aₙ (n = 1, 2, ... n) of the indoor space (S). If the temperature and air velocity in each of the regions Aₙ is obtained based on the distance over which and the time during which the detection sound wave passing through the region Aₙ propagates, the temperature distribution and air velocity distribution in the entire indoor space (S) can be obtained.

In FIG. 8, a plurality of regions (the region surrounded by the broken lines) adjacent to the indoor unit (48) of the air conditioner (40) serve as the first region Ap, and the remaining regions serve as the second region. In other words, in FIG. 8, a plurality of regions located directly below the indoor unit (48) serve as the first region Ap. The first region Ap of this embodiment includes one or more regions Aₙ adjacent to at least either the inlet (66) or the outlets (67) of the indoor unit (48).

A method for measuring the temperature distribution and air velocity distribution in the indoor space (S) will be described below. For ease of explanation, reference is made to FIG. 9.

FIG. 9 illustrates a horizontal cross section of the indoor space (S). The indoor space (S) is divided into twelve regions Aₙ (n = 1 to 12), each four of which are arranged in the top-to-bottom direction and each three of which are arranged in the right-to-left direction.

The speaker (10) and the microphone (20) are installed on the left wall surface of the region A₁ of the indoor space (S). The indoor unit (48) is installed on the ceiling surface in the region A₂. The region A₂ is the first region Ap. The regions except the region A₂ correspond to the second region Aq (A₁, A₃, A₄, ..., A₁₂).

The plurality of detection sound waves transmitted from the speaker (10) propagate toward the right wall surface. Here, the propagation path of the detection sound wave that has reached a portion of the right wall surface in the region A₃ is referred to as a “first propagation path L₁.” The microphone (20) receives the detection sound wave that has reciprocated through the first propagation path L₁.

Likewise, the propagation path of the detection sound wave that has reached a portion of the right wall surface in the region A₆ is referred to as a “second propagation path L₂,” the propagation path of the detection sound wave that has reached a portion of the right wall surface in the region A₉ is referred to as a “third propagation path L₃,” and the propagation path of the detection sound wave that has reached a portion of the right wall surface in the region A₁₂ is referred to as a “fourth propagation path L₄.” The microphone (20) receives the detection sound wave that has reciprocated through each of the second to fourth propagation paths (L₂ to L₄).

Here, the distance Dₘ (m = 1 to 4) of each of the propagation paths Lₘ (m = 1 to 4) is the sum of the distances dₘ, ₙ over which the detection sound wave propagating through the propagation path Lₘ passes through the associated regions Aₙ (n = 1 to 12). Specifically, a first distance D₁ of the first propagation path L₁ is expressed by D₁ = d₁, ₁ + d₁, ₂ + d₁, ₃. A second distance D₂ of the second propagation path L₂ is expressed by D₂ = d_{2,} ₁ + d_{2, 2} + d_{2, 6}. A third distance D₃ of the third propagation path L₃ is expressed by D₃ = d_{3,} ₁ + d_{3,} ₅ + d_{3,} ₉. A fourth distance D₄ of the fourth propagation path L₄ is expressed by d_{4,} ₁ + d_{4,} ₄ + d_{4,} ₅ + d_{4,} ₈ + d_{4,} ₉ + d_{4,} ₁₂.

The temperature distribution in the indoor space (S) is obtained as follows. The following relational expression is satisfied:

$${\text{v}}_{\text{n}} = 331. 5 + α \times {\text{t}}_{\text{n}}$$

where vₙ (n = 1 to 12) represents the propagation velocity (m/s) of the detection sound wave propagating through each region Aₙ, and tₙ (n = 1 to 12) represents the temperature (deg C) of the region Aₙ.

The value “331.5” (m/s) of Formula 1 represents the sound velocity, and α represents a predetermined constant. Here, the air temperature detected by the first temperature sensor (54) can be assumed to be the air temperature in the first region Ap (A₂). This is because the first temperature sensor (54) detects the temperature of air drawn from the first region Ap by the indoor unit (48). For this reason, the intake temperature of air through the inlet (66) of the indoor unit (48) is assumed to be the air temperature in the first region Ap. The propagation velocity v₂ through the first region Ap (A₂) is calculated by entering the value of the air temperature (intake temperature) detected by the first temperature sensor (54) into “t₂” of Formula 1.

The propagation time Tₘ, the propagation distance d_{m,} ₙ, and the propagation velocity vₘ of a detection sound wave satisfy the following relational expression Formula 2:

$$\left[\begin{matrix}{\text{T}}_{1} \\ {\text{T}}_{2} \\ {\text{T}}_{3} \\ {\text{T}}_{4}\end{matrix}\right] = 2 \left[\begin{matrix}{\text{d}}_{11} & {\text{d}}_{12} & {\text{d}}_{13} & {\text{d}}_{14} \\ {\text{d}}_{21} & {\text{d}}_{22} & {\text{d}}_{23} & {\text{d}}_{24} \\ {\text{d}}_{31} & {\text{d}}_{32} & {\text{d}}_{33} & {\text{d}}_{34} \\ {\text{d}}_{41} & {\text{d}}_{42} & {\text{d}}_{43} & {\text{d}}_{44}\end{matrix}\right] \left[\begin{matrix}1 / {\text{v}}_{1} \\ 1 / {\text{v}}_{2} \\ 1 / {\text{v}}_{3} \\ 1 / {\text{v}}_{4}\end{matrix}\right]$$

where the propagation time Tₘ (m = 1 to 4) represents the time during which the detection sound wave propagating through each propagation path Lₙ (n = 1 to 4) reciprocates.

The propagation velocity v₂ through the first region Ap (A₂) calculated by [Formula 1] described above is entered into the system of simultaneous equations defined as [Formula 2]. The propagation velocities vₙ through the regions (A₁, A₃, A₄,..., A₁₂) of the second region Aq can be obtained by calculating the system of simultaneous equations defined as [Formula 2] into which this known value v₂ has been entered using the method of least squares. The temperatures tₙ in the regions (A₁, A₃, A₄, ..., A₁₂) of the second region Aq can be obtained by the propagation velocities vₙ and Formula 1.

Next, the air velocity distribution in the indoor space (S) is obtained as follows. The airflow velocity (m/s) through each of the regions Aₙ is denoted by uₙ (n = 1 to 4). While the sound wave propagates forward through each propagation path Lₙ, the airflow forms a tailwind that follows the propagating sound wave. On the other hand, while the sound wave returns therethrough, the airflow forms a head wind that opposes the propagating sound wave. While the airflow forms a tailwind, the propagation velocity of the detection sound wave increases by the airflow velocity uₙ. On the other hand, while the airflow forms a head wind, the propagation velocity of the detection sound wave decreases by the airflow velocity uₙ. Thus, the propagation velocity vₙₐ during forward propagation of the sound wave (in a situation where the airflow forms a tailwind) and the propagation velocity v_{nb} during return propagation of the sound wave (in a situation where the airflow forms a head wind) satisfy the relational expressions Formula 3 and Formula 4, respectively.

$${\text{v}}_{\text{na}} = 331. 5 + α \times {\text{t}}_{\text{n}} + {\text{u}}_{\text{n}}$$

$${\text{v}}_{\text{ab}} = 331. 5 + α \times {\text{t}}_{\text{n}} - {\text{u}}_{\text{n}}$$

Here, the air velocity of air drawn into the inlet (66) of the indoor unit (48) (intake air velocity) can be assumed to be the air velocity in the first region Ap (A₂). This is because the air in the first region Ap flows toward the inlet (66) of the indoor unit (48). The intake air velocity is calculated based on the rotational speed of the indoor fan (52) and the opening area of the inlet (66). Specifically, the volume of air drawn per unit time can be obtained based on the rotational speed of the indoor fan (52). The air velocity through the inlet (66) can be obtained by dividing the rotational speed of the indoor fan (52) by the opening area. Thus, the propagation velocity v₂ₐ during the forward propagation, and the propagation velocity v_{2b} during the return propagation, through the first region Ap (A₂) are calculated by entering the value of the intake air velocity and the value of the above-described intake temperature into “u₂” and “t₂,” respectively, in each of Formula 3 and Formula 4.

The regions A₃, A₆, A₉, and A₁₂ touch the wall surface. Thus, the air velocity in each of these regions can be supposed to be substantially zero. This is because the friction between the airflow and the wall surface causes the air velocity near the wall surface to be very low. Thus, the propagation velocities v₃ₐ, v₆ₐ, v₉ₐ and v₁₂ₐ during the forward propagation, and the propagation velocities v_{3b}, v_{6b}, v_{9b} and v_{12b}, during the return propagation, through the respective regions A₃, A₆, A₉, and A₁₂ are each calculated by entering zero into an associated one of "u₃," "u₆," "u₉," and "u₁₂" and entering the temperature value obtained by Formula 2 into an associated one of "t₃," "t₆," "t₉," and "t₁₂," in each of Formula 3 and Formula 4.

The propagation time Tₙ of a detection sound wave, the propagation distance dₘₙ, and the propagation velocity vₙ satisfy the following relational expression Formula 5:

$$\begin{matrix}\left[\begin{matrix}{\text{T}}_{1} \\ {\text{T}}_{2} \\ {\text{T}}_{3} \\ {\text{T}}_{4}\end{matrix}\right] = 2 \left[\begin{matrix}{\text{d}}_{1 \text{, 1}} & {\text{d}}_{1 , \text{2}} & … & {\text{d}}_{1 , 12} \\ {\text{d}}_{2 , 1} & {\text{d}}_{2 , \text{2}} & … & {\text{d}}_{2 , 12} \\ {\text{d}}_{3 , 1} & {\text{d}}_{3 , \text{2}} & … & {\text{d}}_{3 , 12} \\ {\text{d}}_{4 , 1} & {\text{d}}_{4 , \text{2}} & … & {\text{d}}_{4 , 12}\end{matrix}\right] \left[\begin{matrix}1 / {\text{v}}_{1} \\ 1 / {\text{v}}_{2} \\ ⋅ \\ ⋅ \\ ⋅ \\ 1 / {\text{v}}_{12 \text{a}}\end{matrix}\right] + \\ \left[\begin{matrix}{\text{d}}_{1 \text{, 1}} & {\text{d}}_{1 , \text{2}} & … & {\text{d}}_{1 , 12} \\ {\text{d}}_{2 , 1} & {\text{d}}_{2 , \text{2}} & … & {\text{d}}_{2 , 12} \\ {\text{d}}_{3 , 1} & {\text{d}}_{3 , \text{2}} & … & {\text{d}}_{3 , 12} \\ {\text{d}}_{4 , 1} & {\text{d}}_{4 , \text{2}} & … & {\text{d}}_{4 , 12}\end{matrix}\right] \left[\begin{matrix}1 / {\text{v}}_{1} \\ 1 / {\text{v}}_{2} \\ ⋅ \\ ⋅ \\ ⋅ \\ 1 / {\text{v}}_{12 \text{a}}\end{matrix}\right]\end{matrix}$$

where the propagation time Tₙ (n = 1 to 4) represents the time during which the detection sound wave propagating through each propagation path Lₙ (n = 1 to 4) reciprocates.

The propagation velocity v₂ₐ during the forward propagation and the propagation velocity v_{2b} during the return propagation through the first region Ap (A₂) respectively calculated by Formula 3 and Formula 4 described above are entered into the system of simultaneous equations defined as Formula 5.

The propagation velocities v₃ₐ, v₆ₐ, v₉ₐ and v₁₂ₐ during the forward propagation and the propagation velocities v_{3b}, v_{6b}, v_{9b} and v_{12b} during the return propagation, through the respective regions A₃, A₆, A₉, and A₁₂ are entered into the system of simultaneous equations as Formula 5. The propagation velocities v₃ₐ, v₆ₐ, v₉ₐ and v₁₂ₐ during the forward propagation have been calculated by Formula 3 described above, and the propagation velocity v_{3b}, v_{6b}, v_{9b} and v_{12b} have been calculated by Formula 4 described above.

In Formula 5, zero is entered into each of the propagation distances (e.g., d_{1,} ₁₂) that are not shown in FIG. 9.

The propagation velocities vₙ in the regions (A₁, A₃, A₄, ..., A₁₂) of the second region Aq can be obtained by calculating the system of simultaneous equations defined as [Formula 5] into which these known values have been entered using the method of least squares. More specifically, addition of another speaker (10) and another microphone (20) or any other method allows the left term (forward propagation) and right term (return propagation) of the right side of [Formula 5] to be separately measured, thereby calculating the values Vₙₐ and V_{nb} from the system of simultaneous equations defined as [Formula 5]. The air velocity in each of the regions Aₙ (n = 1, 3, 4, ..., 12) of the second region Aq can be obtained by the propagation velocities vₙ, [Formula 3], [Formula 4], and the temperature tₙ in the region Aₙ of the second region Aq. The air velocity in each of the regions A₃, A₆, A₉, and A₁₂ is zero.

### Process for Measuring Temperature Distribution and Velocity Distribution

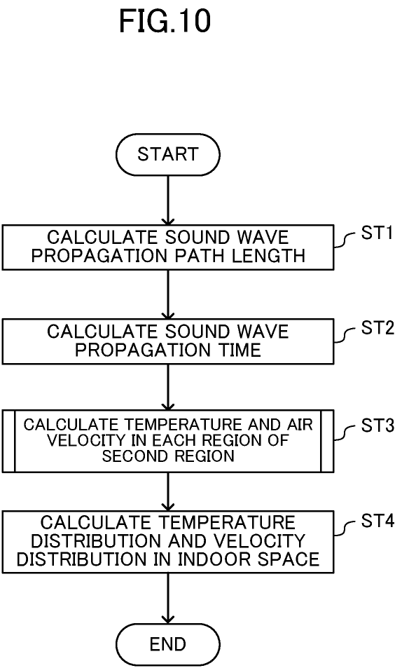

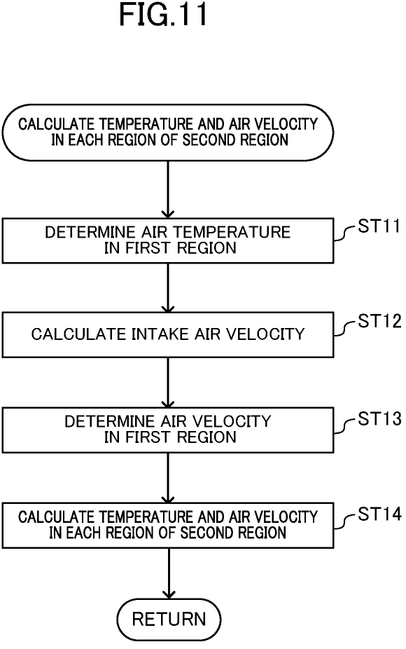

Next, a process in which the environment detection system (1) measures the temperature distribution and the velocity distribution in the indoor space (S) will be described with reference to FIG. 10.

In the following steps ST1 and ST2, the controller (30) acquires measured sound wave data. The measured sound wave data indicates the propagation distance and propagation time of the detection sound wave.

In step ST1, the controller (30) acquires distance information on a plurality of detection sound waves propagating through the indoor space (S) on a region Aₙ-by-region Aₙ basis, from the path information stored in the storage unit (33).

In step ST2, the controller (30) measures the amount of time elapsed between the instant when the speaker (10) transmits a detection sound wave and the instant when the microphone (20) receives the detection sound wave. This amount of time elapsed is used as the propagation time of the detection sound wave.

In step ST3, the controller (30) calculates the temperature and air velocity in each of the regions Aₙ of the second region Aq, based on the temperature and air velocity in the first region Ap, the measured sound wave data derived from steps ST1 and ST2 (the propagation distance and propagation time of the detection sound wave passing through the region Aₙ), and the temperature and air velocity in the first region Ap. The controller (30) records the calculated temperature and air velocity in the region Aₙ of the second region Aq in the storage unit (33).

In step ST4, the controller (30) measures the temperature distribution and air velocity distribution in the indoor space (S), based on the temperature and air velocity in each region Aₙ that have been calculated in step ST3.

### Calculation of Temperature and Air Velocity in Second Region

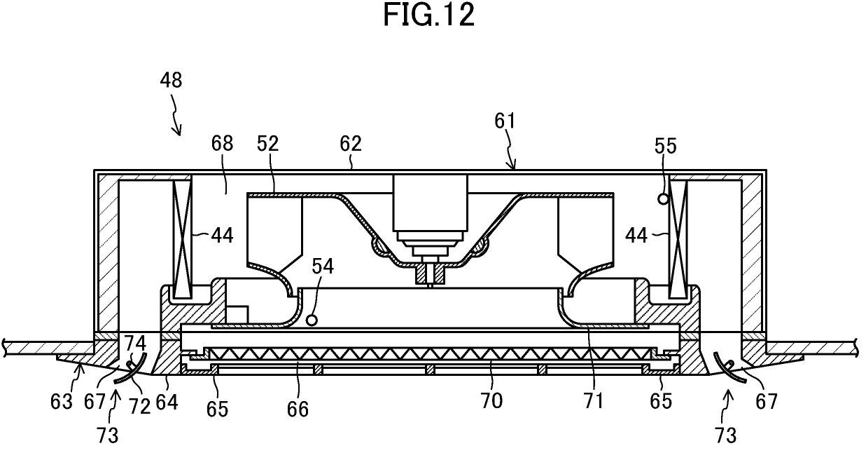

A process in which the controller (30) measures the temperature and air velocity in the second region Aq in step ST3 will be described with reference to FIG. 11.

In step ST11, the controller (30) determines that the air temperature (intake temperature) that is included in the acquired information acquired from the communication unit (103) and that is detected by the first temperature sensor (54) is the air temperature in the first region Ap.

In step ST12, the controller (30) calculates the air velocity (intake air velocity), based on the rotational speed of the indoor fan (52) and the opening area of the inlet (66) that are included in the acquired information acquired from the communication unit (103).

In step ST13, the controller (30) determines that the intake air velocity is the air velocity in the first region Ap.

In step ST14, the controller (30) obtains the propagation velocity in the first region Ap, based on the temperature in the first region Ap determined in step ST11. The controller (30) calculates the temperature in each region Aₙ of the second region Aq, based on the propagation velocity in the first region Ap and the measured sound wave data. Specifically, [Formula 2] described above will be described as an example. The value detected by the first temperature sensor (54) (intake temperature) is assigned to the temperature t₂ in the first region Ap in the system of simultaneous equations defined as [Formula 2]. Solving this system of simultaneous equations allows the temperature in each region Aₙ of the second region Aq to be calculated.

The controller (30) obtains the propagation velocity in the first region Ap, based on the air velocity in the first region Ap determined in step ST13. The controller (30) calculates the air velocity in each region Aₙ of the second region Aq, based on the propagation velocity in the first region Ap and the measured sound wave data. Specifically, [Formula 5] described above will be described as an example. The intake air velocity calculated in step S12 is assigned to the air velocity u₂ in the first region Ap in the system of simultaneous equations defined as [Formula 5]. Solving this system of simultaneous equations allows the air velocity in each region Aₙ of the second region Aq to be calculated.

### Feature (1) of Embodiment

The environment detection system (1) according to the embodiment includes the speaker (10) (sound wave transmitter) configured to transmit a detection sound wave to an indoor space (S) (target space) where the air conditioner (40) is installed, the microphone (20) (sound wave receiver) configured to receive the detection sound wave transmitted by the speaker (10), and the controller (30) (control unit) configured to control the speaker (10), and further includes a determination unit (32) configured to determine at least either the temperature or air velocity in the first region Ap, based on the predetermined acquired information acquired from the air conditioner (40). The temperature distribution and air velocity distribution in the second region Aq of the indoor space (S) except the first region Ap are obtained based on the temperature and air velocity in the first region Ap determined by the determination unit (32) and the measured sound wave data.

Here, a system in which the temperature distribution and air velocity distribution in a space are measured using sound waves calculates the temperature and air velocity in a space, based on the propagation time and propagation distance of a sound wave. The actual measurement values of the temperature and air velocity in the space are not directly acquired. Thus, measuring each of these values using sound waves may cause the error from the associated actual measurement value to be relatively large. The propagation distance of the sound wave, in particular, through a relatively large space increases, resulting in an increase in attenuation. In addition, the number of reflections off the wall surfaces, the floor surface, and other surfaces, the reflection coefficient, and other factors may increase the attenuation even in a relatively small space. In such a case, measuring the temperature distribution and air velocity distribution in the space using sound waves may prevent the accuracy of this measurement from being stable.

To address this problem, the temperature and air velocity at a predetermined location in the space may be actually measured, and a value of temperature measured using sound waves may be corrected, based on the actual measurement value of the temperature. This creates a need to separately provide a temperature sensor and an air velocity sensor, resulting in an increase in the number of components. In addition, a need arises to previously secure the location to which such a temperature sensor or such an air velocity sensor is to be attached in the space.

In contrast, according to the feature (1) of the embodiment, the temperature and air velocity in the first region Ap near the air conditioner (40) are determined by the acquired information acquired from the air conditioner (40). The temperature distribution and air velocity distribution in the second region Aq are calculated, based on the temperature and air velocity in the first region Ap and the measured sound wave data. Thus, when the temperature distribution and air velocity distribution in the entire indoor space (S) are to be measured, the temperature and air velocity derived based on the acquired information can be used for the first region Ap. As a result, the accuracies of measurement of the temperature and air velocity in each region Aₙ of the second region Aq can be improved, and the reliability of the results of measurement of the temperature distribution and air velocity distribution in the indoor space (S) can be improved, as compared with the case where calculation is performed based on only the measured sound wave data.

### Feature (2) of Embodiment

In the environment detection system (1) of the embodiment, the acquired information is the intake temperature that is the temperature of air drawn through the inlet (66) by the air conditioner (40). The determination unit (32) determines that the intake temperature is the temperature in the first region Ap. The temperature distribution in the second region Aq is obtained based on the temperature in the first region Ap determined by the determination unit (32) and the measured sound wave data.

According to the feature (2) of the embodiment, the intake temperature of the air conditioner (40) is determined to be the temperature in the first region Ap. This eliminates the need for separately providing a temperature sensor in the first region Ap. This can reduce an increase in the number of components forming the environment detection system (1).

In addition, the air temperature in the first region Ap is substantially the same as the intake temperature of the air conditioner (40). The intake temperature can be accurately detected by the first temperature sensor (54). Thus, determining the value detected by the first temperature sensor (54) to be the temperature in the first region Ap improves the accuracy of measurement of the temperature in each region Aₙ of the second region Aq.

### Feature (3) of Embodiment

In the environment detection system (1) of the embodiment, the acquired information corresponds to the rotational speed of the indoor fan (52) (fan) and the opening area of the inlet (66). The determination unit (32) calculates the intake air velocity that is the velocity of air drawn into the inlet (66) of the air conditioner (40), based on the acquired information, determines that the intake air velocity is the air velocity in the first region Ap, and obtains the air velocity distribution in the second region Aq, based on the air velocity in the first region Ap determined by the determination unit (32) and the measured sound wave data.

According to the feature (3) of the embodiment, the intake air velocity of the air conditioner (40) is determined to be the air velocity in the first region Ap. This eliminates the need for separately providing an air velocity sensor in the first region Ap. This can reduce an increase in the number of components forming the environment detection system (1).

In addition, the intake air velocity can be relatively accurately calculated based on the rotational speed of the indoor fan (52) and the opening area of the inlet (66). Thus, determining the value of air velocity calculated from the acquired information to be the value of air velocity in the first region Ap improves the accuracy of measurement of the air velocity in each region Aₙ of the second region Aq.

### Feature (4) of Embodiment

In the environment detection system (1) of the embodiment, the second region Aq is divided into the plurality of regions Aₙ. The air velocity distribution in the second region Aq is obtained, where the air velocity in some of the regions Aₙ touching the wall surfaces, the floor surface, and the ceiling surface of the indoor space (S) is zero.

According to the feature (4) of the embodiment, some of the air velocities uₙ in Formula 5 corresponding to the regions A₃, A₆, A₉, and A₁₂ touching the wall surface, for example, can be entered as zero. This increases the number of known values entered into [Formula 5] in addition to the air velocity in the first region Ap. As a result, the accuracy of the air velocity distribution in the second region Aq can be reliably improved.

### Variation

In an environment detection system (1) of the variation, the air temperature and air velocity in the first region Ap are determined to be the temperature and velocity, respectively, of air blown out of the outlet (67) of the air conditioner (40). Thus, differences from the environment detection system (1) of the embodiment will be described below.

### Indoor Unit

As illustrated in FIG. 12, the indoor unit (48) includes a second temperature sensor (55). The second temperature sensor (55) detects the temperature of the indoor heat exchanger (44). Specifically, an electrode (a part that detects the temperature) of the second temperature sensor (55) touches the surface of the indoor heat exchanger (44).

The second temperature sensor (55) is connected to the control device (100) in a wired or wireless manner. Information on the temperature detected by the second temperature sensor (55) is entered into the input unit (102) of the control device (100). The acquired information transmitted to the controller (30) of the air conditioner (40) by the communication unit (103) includes information on the temperature detected by the second temperature sensor (55).

### Environment Detection System

The acquired information received by the controller (30) includes the temperature of the heat exchanger (44), the temperature of the air drawn through the inlet (66), the rotational speed of the indoor fan (52), the orientation of each flap (72), and the opening area of each outlet (67). The temperature of the heat exchanger (44) is the temperature detected by the second temperature sensor (55). The temperature of the air drawn through the inlet (66) is the temperature detected by the first temperature sensor (54). The flap (72) is oriented in any one of its five open positions.

### Measurement of Temperature Distribution and Air Velocity Distribution

The temperature of air blown out of the outlets (67) of the indoor unit (48) (blow-out temperature) can be assumed to be the air temperature in the first region Ap. This is because the air temperature in the first region Ap is substantially the same as the temperature of the air blown out of the outlets (67) of the indoor unit (48) into the first region Ap.

The blow-out temperature is calculated based on the temperature of the indoor heat exchanger (44), the temperature of the air drawn into the inlet (66), the rotational speed of the indoor fan (52), and the orientation of each flap (72).

Specifically, the blow-out temperature is calculated using the temperature difference ΔT between the temperature of the intake air drawn into the inlet (66) and the temperature of the indoor heat exchanger (44), the amount J of heat exchanged with the intake air by the indoor heat exchanger (44), and the volume V of air passing through the indoor heat exchanger (44). The temperature difference ΔT is calculated using the difference between the temperatures respectively detected by the first and second temperature sensors (54) and (55). The amount J of heat is calculated based on the temperature difference ΔT and the known properties of the indoor heat exchanger (44). The volume V of the air is calculated based on the rotational speed of the indoor fan (52) and the open position of each flap (72). The temperature of the air that has passed through the indoor heat exchanger (44) can be calculated as the blow-out temperature, based on the volume V of the air and the amount J of the heat.

The velocity of the air blown out of the outlets (67) of the indoor unit (48) (blow-out air velocity) can be assumed to be the air velocity in the first region Ap. This is because the velocity of the air in the first region Ap is substantially the same as the flow rate of the air blown out of the outlets (67) of the indoor unit (48).

The blow-out air velocity is calculated based on the rotational speed of the indoor fan (52), the opening area of each outlet (67), and the orientation of each flap (72).

Specifically, the volume of air blown per unit time can be obtained based on the rotational speed of the indoor fan (52). The substantial opening area of each outlet (67) can be determined by the open position of the associated flap (72). The air velocity through the outlet (67) can be obtained by dividing the rotational speed of this indoor fan (52) by the substantial opening area of the outlet (67).

### Measuring Process of Temperature and Air Velocity in Second Region

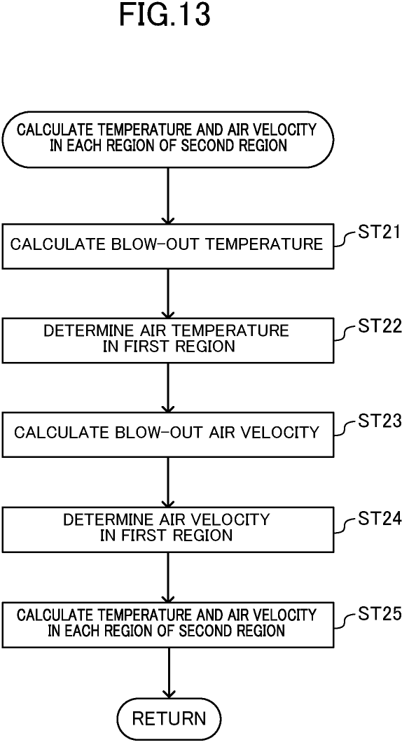

As shown in FIG. 13, the temperature and air velocity in the second region in the variation are calculated by the following process.

In step ST21, the controller (30) calculates the blow-out temperature that is the temperature of air blown out of the outlets (67) of the indoor unit (48), based on the temperature of the heat exchanger (44), the temperature of air drawn through the inlet (66), the rotational speed of the indoor fan (52), and information indicating that the flaps (72) are in their open state, which are included in acquired information acquired from the communication unit (103).

In step ST22, the determination unit (32) of the controller (30) determines that the blow-out temperature calculated in step ST21 is the temperature of air in the first region Ap.

In step ST23, the controller (30) calculates the velocity of air blown out of the outlets (67) of the indoor unit (48) (blow-out air velocity), based on the rotational speed of the indoor fan (52), the opening area of the inlet (67), and the open position of each flap (72), which are included in the acquired information acquired from the communication unit (103).

In step ST24, the controller (30) determines that the blow-out air velocity calculated in step ST23 is the air velocity in the first region Ap.

In step ST25, the controller (30) obtains the propagation velocity in the first region Ap, based on the temperature in the first region Ap determined in step ST22. The controller (30) calculates the temperature in each region Aₙ of the second region Aq, based on the propagation velocity in the first region Ap and the measured sound wave data. Specifically, [Formula 2] described above will be described as an example. The blow-out temperature calculated in step ST21 is assigned to the temperature t₂ in the first region Ap in the system of simultaneous equations defined as [Formula 2]. Solving this system of simultaneous equations allows the temperature in each region Aₙ of the second region Aq to be calculated.

The controller (30) obtains the propagation velocity in the first region Ap, based on the air velocity in the first region Ap determined in step ST24. The controller (30) calculates the air velocity in each region Aₙ of the second region Aq, based on the propagation velocity in the first region Ap and the measured sound wave data. Specifically, [Formula 5] described above will be described as an example. The blow-out air velocity calculated in step ST23 is assigned to the air velocity u₂ in the first region Ap in the system of simultaneous equations defined as [Formula 5]. Solving this system of simultaneous equations allows the air velocity in each region Aₙ of the second region Aq to be calculated.

Also in this variation, the blow-out temperature and the blow-out air velocity of the indoor unit (48) are determined to be the temperature and air velocity in the first region Ap, respectively. This eliminates the need for separately providing a temperature sensor and an air velocity sensor in the first region Ap. The temperature and air velocity in each region Aₙ of the second region Aq are measured based on the temperature and air velocity in the first region Ap determined by the determination unit (32) and the measured sound wave data. This can improve the accuracies of measurement of the temperature distribution and air velocity distribution in the indoor space (S) as compared with the case where only the measured sound wave data is used.

### SECOND EMBODIMENT

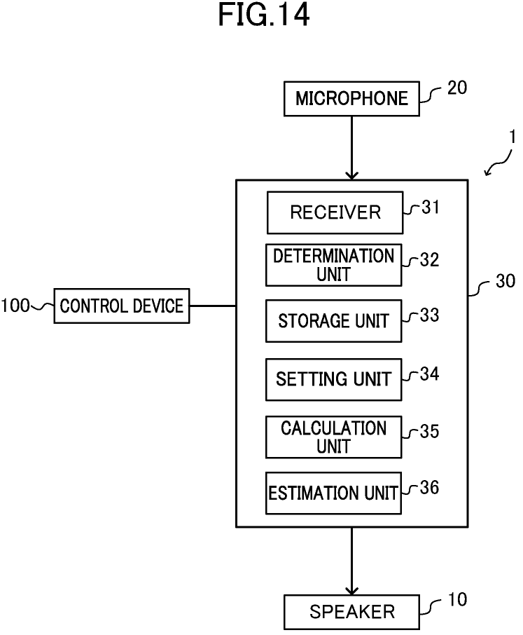

An environment detection system (1) of the second embodiment estimates the effectiveness of ventilation of an indoor space (S) based on the air velocity distribution in the indoor space (S). Specifically, as shown in FIG. 14, a controller (30) of the environment detection system (1) of this example includes a calculation unit (35) and an estimation unit (36).

The calculation unit (35) obtains the air age distribution in the indoor space (S) based on the air velocity distribution in the indoor space (S). Specifically, the calculation unit (35) obtains the air age distribution in the indoor space (S) based on the calculated air velocity in each region Aₙ of the second region Aq. More specifically, the calculation unit (35) obtains the air age distribution based on the air velocity distribution in the second region Aq, by using a predetermined arithmetic expression. The air age is the time taken for the air that has flowed into the indoor space (S) to reach a certain location in the indoor space (S). The location at which the air age is lower indicates that air at this location is fresher, whereas the location at which the air age is higher indicates that air at this location is more stagnant. As can be seen, the air age enables grasping of the state of stagnation in the indoor space (S). For example, a passive scalar equation can be used as the predetermined arithmetic expression.

The estimation unit (36) estimates the stagnation of the air from the air age distribution in the indoor space (S). Specifically, the estimation unit (36) estimates the air age in each region Aₙ calculated by the calculation unit (35). The estimation unit (36) estimates that some of the regions Aₙ where the air age is relatively high contain relatively stagnant air. In contrast, the estimation unit (36) estimates that some of the regions Aₙ where the air age is relatively low contain relatively fresh air. In this manner, the estimation performed by the estimation unit (36) enables grasping of non-uniform air age distribution in the indoor space (S). An example of how the stagnation of the air in the indoor space (S) is estimated will be described below.

As shown in FIG. 15, a ventilator (80) is provided for the indoor space (S). The ventilator (80) has an air supply port (81) and an exhaust port (82). The exhaust port (82) is disposed in a diagonal line when the indoor space (S) is viewed from above. Air blown out of the air supply port (81) passes through the indoor space (S), and is discharged through the exhaust port (82) to the outside. In the indoor space (S), an airflow is generated by blowing the air out of the air supply port (81) and exhausting the air toward the exhaust port (82).

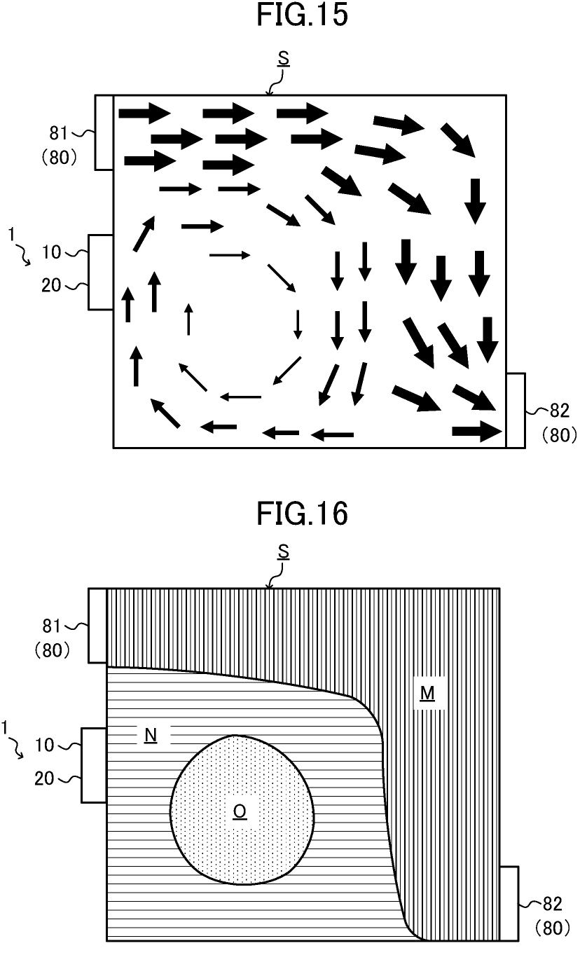

In FIG. 15, the air velocity distribution in the indoor space (S) is indicated by the arrows. The thickness of each arrow indicates the magnitude of the air velocity. The thicker the arrow is, the higher the air velocity is. The direction of the arrow indicates the direction in which air flows. As illustrated in FIG. 16, the air velocity V_{M} in a region M of the indoor space (S) shaded with vertical lines is higher, the air velocity V_{N} in a region N of the indoor space (S) shaded with horizontal lines is lower, and the air velocity Vo in a region O of the indoor space (S) shaded with dots is further lower (V_{M} > V_{N} > V_{O}).

The air ages in the regions M, N, and O obtained by the calculation unit (35) are supposed to be one second, 10 seconds, and 20 seconds, respectively. Based on such an air age distribution in the indoor space (S), the estimation unit (36) estimates that air in the region M is freshest and that air in the region O is most stagnant. In addition, the estimation unit (36) estimates that air in the region N is fresher than the air in the region O and is more stagnant than the air in the region M. The estimation unit (36) may show an index indicating the degree of stagnation of air in each region based on the air ages calculated by the calculation unit (35).

According to this example, the effectiveness of ventilation of the indoor space (S) can be estimated. Even if the amount of ventilation is adequate, estimating non-uniform air age distribution in the indoor space (S) enables grasping of whether the entire indoor space (S) has been adequately ventilated. Thus, for example, in the ventilator (80), regulating the positions of the air supply port (81) and the exhaust port (82) and the directions of the openings can improve the ventilation efficiency of the entire indoor space (S).

In addition, when a predetermined threshold value is set for the air age, and a determination is made that the air age has exceeded the threshold value, increasing the blow-out air velocity and the intake air velocity can reduce the air age in the region Aₙ where the air age has exceeded the threshold value. Such efficient ventilation can reduce an increase in the risk of infection by pathogenic bacteria and other factors floating in the air in the indoor space (S).

### OTHER EMBODIMENTS

The environment detection system (1) of the present disclosure may detect either the temperature distribution or the air velocity distribution.

In the environment detection system (1) of the present disclosure, the speaker (10) and the microphone (20) may be separately installed at different locations in the indoor space (S).

In the environment detection system (1) of the present disclosure, the temperature and air velocity in the first region Ap may be used as the blow-out temperature and the intake air velocity, respectively. Alternatively, the temperature and air velocity in the first region Ap may be used as the intake temperature and the blow-out air velocity, respectively.

In the environment detection system (1) of the present disclosure, the determination unit (32) may select whether the air temperature in the first region Ap is used as the intake temperature or as the blow-out temperature, based on the open position of each flap (72). In addition, the determination unit (32) may select whether the air velocity in the first region Ap is defined as the intake air velocity or the blow-out air velocity, based on the open position of the flap (72). For example, when the open position of the flap (72) is the most upward position (horizontal blow-out position), the substantial opening area of the outlet (67) is minimum. In this case, an airflow from the outlet (67) passes through only a small portion of the first region Ap. For this reason, the air velocity in the first region Ap is hardly affected by the airflow. Thus, while the flap (72) is in the horizontal blow-out position, the determination unit (32) determines that the intake temperature is the temperature in the first region Ap and that the intake air velocity is the air velocity in the first region Ap. On the other hand, while the flap (72) is in the most downward position, an airflow from the outlet (67) flows through a large portion of the first region Ap. For this reason, the air velocity in the first region Ap can be assumed to be substantially the same as the flow rate of the airflow from the outlet (67). Thus, while the flap (72) is in the most downward position, the determination unit (32) determines that the blow-out temperature is the temperature in the first region Ap and that the blow-out air velocity is the air velocity in the first region Ap.

In the environment detection system (1) of the present disclosure, the first region Ap is not limited to a region adjacent to the indoor unit (48). The first region Ap merely needs to be a region where the temperature and the air velocity obtained from the acquired information can be assumed to be the temperature and velocity of the air in the first region Ap. For example, the first region Ap may be a region where the temperature detected by the first temperature sensor (54) can be assumed to be the air temperature in the first region Ap.

In the environment detection system (1) of the present disclosure, the number of the speaker(s) (10) and the number of the microphone(s) (20) in the indoor space (S) are not each limited to one, and may be two or more.

In the environment detection system (1) of the present disclosure, the location at which the speaker (10) and the microphone (20) are installed is not limited to the ceiling of the indoor space (S). The speaker (10) and the microphone (20) may be installed on the wall surface or floor surface of the indoor space (S). The speaker (10) and the microphone (20) may be installed in the indoor unit (48).

“Air conditioning” as used herein includes not only “regulation of temperature and humidity” but also “regulation of cleanliness and an airflow.” Thus, the environment control device (40) of the present disclosure is not limited to an air conditioner that cools and heats an indoor space, and may be, for example, a ventilator or an air cleaner.

While the embodiments and the variations thereof have been described above, it will be understood that various changes in form and details may be made without departing from the spirit and scope of the claims. The embodiments and the variations thereof may be combined and replaced with each other without deteriorating intended functions of the present disclosure. The expressions of “first,” “second,” ... described above are used to distinguish the terms to which these expressions are given, and do not limit the number and order of the terms.

As can be seen from the foregoing description, the present disclosure is useful for an environment detection system.

1. An environment detection system, comprising:
a sound wave transmitter configured to transmit a detection sound wave to a target space where an environment control device configured to condition air in a space is installed;
a sound wave receiver configured to receive the detection sound wave transmitted by the sound wave transmitter; and
a determination unit configured to determine at least either a temperature or an air velocity in a first region near the environment control device, based on predetermined acquired information acquired from the environment control device,
the environment detection system being configured to obtain at least either a temperature distribution or an air velocity distribution in the target space, based on measured sound wave data including a length of a sound wave propagation path and a sound wave propagation time, from when the sound wave transmitter transmits the detection sound wave to when the sound wave receiver receives the detection sound wave,
at least either a temperature distribution or an air velocity distribution in a second region of the target space different from the first region being obtained based on at least either the temperature or the air velocity in the first region determined by the determination unit and the measured sound wave data.

2. The environment detection system of claim 1, wherein
the environment control device is an air conditioner including
an inlet through which air is drawn from the target space and
an outlet through which air is blown into the target space,
the acquired information is an intake temperature of the air drawn through the inlet by the air conditioner,
the determination unit is configured to determine that the intake temperature is a temperature in the first region, and
the temperature distribution in the second region is obtained based on the temperature in the first region determined by the determination unit and the measured sound wave data.

3. The environment detection system of claim 1, wherein
the environment control device is an air conditioner including,
an inlet through which air is drawn from the target space,
a heat exchanger configured to regulate a temperature of the air drawn through the inlet,
an outlet through which air that has passed through the heat exchanger is blown into the target space,
a fan configured to send air from the inlet to the outlet, and
a flap configured to regulate a direction of air blown out of the outlet,
the acquired information includes a temperature of the heat exchanger, the temperature of the air drawn through the inlet, a rotational speed of the fan, and an orientation of the flap,
the determination unit is configured to
calculate a blow-out temperature of the air blown out of the outlet of the air conditioner, based on the acquired information, and
determine that the blow-out temperature is the temperature in the first region, and
the temperature distribution in the second region is obtained based on the temperature in the first region determined by the determination unit and the measured sound wave data.

4. The environment detection system of claim 1, wherein
the environment control device is an air conditioner including
an inlet through which air in the target space is drawn,
an outlet through which air is blown into the target space, and
a fan configured to send air from the inlet to the outlet,
the acquired information includes a rotational speed of the fan and an opening area of the inlet,
the determination unit is configured to
calculate an intake air velocity that is a velocity of the air drawn into the inlet of the air conditioner, based on the acquired information, and
determine that the intake air velocity is the air velocity in the first region, and
the air velocity distribution in the second region is obtained based on the air velocity in the first region determined by the determination unit and the measured sound wave data.

5. The environment detection system of claim 1, wherein
the environment control device is an air conditioner including
an inlet through which air in the target space is drawn,
an outlet through which air is blown into the target space,
a fan configured to send air from the inlet to the outlet, and
a flap configured to regulate a direction of air blown out of the outlet,
the acquired information includes a rotational speed of the fan, an opening area of the inlet, and an orientation of the flap,
the determination unit is configured to
calculate a blow-out air velocity that is a velocity of the air blown out of the outlet of the air conditioner, based on the acquired information, and
determine that the blow-out air velocity is the air velocity in the first region, and
the air velocity distribution in the second region is obtained based on the air velocity in the first region determined by the determination unit and the measured sound wave data.

6. The environment detection system of claim 1, wherein
the second region is further divided into a plurality of regions, and
the determination unit is configured to obtain the air velocity distribution in the second region, where an air velocity in each of some of the regions touching a wall surface, a floor surface, and a ceiling surface of the target space is zero.

7. The environment detection system of claim 2, wherein
the second region is further divided into a plurality of regions, and
the determination unit is configured to obtain the air velocity distribution in the second region, where an air velocity in each of some of the regions touching a wall surface, a floor surface, and a ceiling surface of the target space is zero.

8. The environment detection system of claim 3, wherein
the second region is further divided into a plurality of regions, and
the determination unit is configured to obtain the air velocity distribution in the second region, where an air velocity in each of some of the regions touching a wall surface, a floor surface, and a ceiling surface of the target space is zero.

9. The environment detection system of claim 4, wherein
the second region is further divided into a plurality of regions, and
the determination unit is configured to obtain the air velocity distribution in the second region, where an air velocity in each of some of the regions touching a wall surface, a floor surface, and a ceiling surface of the target space is zero.

10. The environment detection system of claim 5, wherein
the second region is further divided into a plurality of regions, and
the determination unit is configured to obtain the air velocity distribution in the second region, where an air velocity in each of some of the regions touching a wall surface, a floor surface, and a ceiling surface of the target space is zero.

11. The environment detection system of claim 1, further comprising:
a calculation unit configured to obtain an air age distribution in the target space, based on the air velocity distribution in the second region.

12. The environment detection system of claim 2, further comprising:
a calculation unit configured to obtain an air age distribution in the target space, based on the air velocity distribution in the second region.

13. The environment detection system of claim 3, further comprising:
a calculation unit configured to obtain an air age distribution in the target space, based on the air velocity distribution in the second region.

14. The environment detection system of claim 4, further comprising:
a calculation unit configured to obtain an air age distribution in the target space, based on the air velocity distribution in the second region.

15. The environment detection system of claim 5, further comprising:
a calculation unit configured to obtain an air age distribution in the target space, based on the air velocity distribution in the second region.

16. The environment detection system of claim 6, further comprising:
a calculation unit configured to obtain an air age distribution in the target space, based on the air velocity distribution in the second region.

17. The environment detection system of claim 7, further comprising:
a calculation unit configured to obtain an air age distribution in the target space, based on the air velocity distribution in the second region.

18. The environment detection system of claim 8, further comprising:
a calculation unit configured to obtain an air age distribution in the target space, based on the air velocity distribution in the second region.

19. The environment detection system of claim 9, further comprising:
a calculation unit configured to obtain an air age distribution in the target space, based on the air velocity distribution in the second region.

20. The environment detection system of claim 10, further comprising:
a calculation unit configured to obtain an air age distribution in the target space, based on the air velocity distribution in the second region.
